(19) United States
(12) Patent Application Publication
(10) Pub. No.: US 2025/0341620 A1
(43) Pub. Date: Nov. 6, 2025

(54) FOURIER EMBEDDING OF AMPLITUDE AND PHASE FOR SINGLE-IMAGE DEPTH RECONSTRUCTION

(71) Applicants: Trustees of Dartmouth College, Hanover, NH (US); William Marsh Rice University, Houston, TX (US)

(72) Inventors: Adithya Pediredla, Hanover, NH (US); Sarah Friday, West Lebanon, NH (US); Yunzi Shi, Lebanon, NH (US); Vishwanath Saragadam, Corona, CA (US)

(21) Appl. No.: 19/196,989

(22) Filed: May 2, 2025

Related U.S. Application Data
(60) Provisional application No. 63/641,921, filed on May 2, 2024.

(51) Int. Cl. G01S 7/4913; G01S 7/493; G01S 17/894; G03H 1/00; H04N 23/56; H04N 23/81; H04N 25/53

(52) U.S. Cl. CPC G01S 7/4913; G01S 7/493; G01S 17/894; G03H 1/0005; H04N 23/56; H04N 23/81; H04N 25/53; G03H 2001/0033

(57) ABSTRACT

A system has at least one continuous-wave amplitude modulated time-of-flight camera and at least one processor in electronic communication with the at least one continuous-wave amplitude modulated time-of-flight camera. The at least one processor may be configured to determine an amplitude and phase together as a single time-of-flight hologram and embed the time-of-flight hologram in a Fourier transform of a single measured image.

### CROSS-REFERENCE TO RELATED APPLICATIONS

This application claims priority to U.S. Provisional Patent Application No. 63/641,921, filed on May 2, 2024, the entire disclosure of which is incorporated herein by reference.

### FIELD OF THE DISCLOSURE

This disclosure relates to image processing.

### BACKGROUND OF THE DISCLOSURE

Amplitude modulated continuous-wave time-of-flight (AMCW-ToF) cameras, also known as correlation-based time-of-flight or indirect time-of-flight cameras, are used as flash Lidars to compute scene depth, and are used in autonomous navigation, robotics, and augmented reality. AMCW-ToF cameras operate by projecting a temporally varying (often a sinusoidal) light source, and then correlating it on the sensor side with an appropriate (also often a sinusoid) decoding function. Depth is encoded in the phase of the measurements, and hence up to four measurements (quadrature) are required to robustly estimate the depth and intensity of the scene. These quadrature measurements are captured by temporal multiplexing, which invariably leads to lower frame rates and suffers from motion artifacts.

The standard use of continuous-wave time-of-flight (CW-ToF) cameras requires illuminating the scene with sinusoidal modulation and demodulating quadrature measurements to recover scene amplitude and depth. The need for four measurements tends to make these systems slow. Any motion of the camera or objects during the acquisition of these four measurements can lead to inaccuracies in the depth reconstruction.

Therefore, improved systems and techniques are needed.

### BRIEF SUMMARY OF THE DISCLOSURE

The present disclosure provides a system that may include a plurality of continuous-wave amplitude modulated time-of-flight cameras and at least one processor in electronic communication with the continuous-wave amplitude modulated time-of-flight cameras. In an embodiment, the at least one processor may be configured to determine an amplitude and phase together as a single time-of-flight hologram and embed the time-of-flight hologram in a Fourier transform of a single measured image.

In an aspect of the present disclosure, the amplitude and a depth may be measured using a single capture.

In an aspect of the present disclosure, the single time-of-flight hologram may be a complex sinusoid, and the amplitude and the phase may be proportional to an intensity and a depth of a scene.

In an aspect of the present disclosure, each of the continuous-wave amplitude modulated time-of-flight cameras may have an illumination source whose amplitude changes sinusoidally.

In an aspect of the present disclosure, each of the continuous-wave amplitude modulated time-of-flight cameras may use a defocused cylindrical lens.

In an aspect of the present disclosure, each of the continuous-wave amplitude modulated time-of-flight cameras may use a rolling shutter.]

In an aspect of the present disclosure, the defocused cylindrical lens may be configured to prefilter images. For example, in an embodiment, images that were taken with a defocused lens may be captured making the image slightly blurry (prefilter). These images may go through a reconstruction process.

In an aspect of the present disclosure, a 1D sinc function or a Gaussian function may be used in the prefilter.

The present disclosure further provides a method may include receiving, at least one processor, images from a plurality of continuous-wave amplitude modulated time-of-flight cameras, determining, using the at least one processor, an amplitude and phase together as a single time-of-flight hologram, and embedding the time-of-flight hologram in a Fourier transform of a single measured image using the at least one processor.

In an aspect of the present disclosure, the amplitude and a depth may be measured using a single capture.

In an aspect of the present disclosure, the single time-of-flight hologram may be a complex sinusoid, and the amplitude and the phase may be proportional to an intensity and a depth of a scene.

In an aspect of the present disclosure, each of the continuous-wave amplitude modulated time-of-flight cameras may have an illumination source whose amplitude changes sinusoidally.

In an aspect of the present disclosure, each of the continuous-wave amplitude modulated time-of-flight cameras may use a defocused cylindrical lens.

In an aspect of the present disclosure, each of the continuous-wave amplitude modulated time-of-flight cameras may use a rolling shutter.

In an aspect of the present disclosure, the method may further include prefiltering images using the defocused cylindrical lens.

In an aspect of the present disclosure, a 1D sinc function or a Gaussian function may be used in the prefiltering.

The present disclosure even further provides a non-transitory computer-readable storage medium, that may include one or more programs for executing the following steps on one or more computing devices: receive images from a plurality of continuous-wave amplitude modulated time-of-flight cameras; determine an amplitude and phase together as a single time-of-flight hologram; and embed the time-of-flight hologram in a Fourier transform of a single measured image.

In an aspect of the present disclosure, the single time-of-flight hologram may be a complex sinusoid, and the amplitude and the phase may be proportional to an intensity and a depth of a scene.

In an aspect of the present disclosure, the steps may further include prefiltering images using a defocused cylindrical lens.

In an aspect of the present disclosure, a 1D sinc function or a Gaussian function may be used in the prefiltering.

### DESCRIPTION OF THE DRAWINGS

For a fuller understanding of the nature and objects of the disclosure, reference should be made to the following detailed description taken in conjunction with the accompanying drawings.

FIG. 1 displays an embodiment of a snapshot Lidar imaging system as disclosed herein.

FIG. 2 displays a diagram of CW-ToF imaging systems.

FIGS. 3A-3E display an example of snapshot CW-ToF decoding and the effect of prefiltering, as disclosed herein.

FIG. 4A displays an embodiment of the hardware setup of Examples 1 and 2.

FIG. 4B displays an embodiment of the emulation method as disclosed herein.

FIG. 5 displays the advantages of the emulated snapshot capture as disclosed herein.

FIG. 6 displays a comparison between an embodiment of a 1D pre-filter and 2D pre-filter, such as a cylindrical lens versus a spherical lens.

FIGS. 7A-7B displays graphical representation of optimal prefilter size and phase variation rate.

FIG. 8 displays a visualization of the effect of changing the phase variation rate.

FIGS. 9A-9B displays a comparison between a Fourier technique and a N-bucket technique for different phase variation rates and pre-filter sizes.

FIG. 10 displays comparisons against quadrature reconstruction.

FIG. 11A displays a comparison of the robustness to local error/oversaturation between conventional techniques and embodiments disclosed herein. Shown is a comparison against the quadrature reconstruction technique for a scene with challenging optical effects such as shiny objects and clear objects.

FIG. 11B displays a comparison between conventional techniques and embodiments disclosed herein for a moving scheme.

FIG. 12 displays an example of improving reconstruction by rotating the camera.

FIGS. 13A-13B display embodiments of an overview of the Fourier transform based reconstruction technique.

FIG. 14 displays a comparison between an embodiment of the technique disclosed herein and an ESPROS reconstruction method at optimal σ values, plotted as points on the SNR graph.

FIG. 15 displays SNR[db] as a function of varying prefilter kernel size for both a 1D and 2D Gaussian filter kernel on a snapshot phase reconstruction.

FIG. 16 displays that phase reconstruction quality for a given scene depends on R and a, as defined in Example 1.

FIG. 17 displays more visualizations of FIG. 16.

FIG. 18 displays a comparison between the N-bucket and Fourier reconstruction techniques.

FIG. 19 displays the effects of titling the camera on intensity and phase reconstructions with no prefilter.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

Embodiments of the present disclosure may be referred to as Snapshot, Snapshot imaging, Snapshot methods, or other variations using the term Snapshot.

The present disclosure includes a snapshot Lidar that captures amplitude and phase simultaneously as a single time-of-flight hologram.

To address the deficiencies in the previous systems, embodiments of the present disclosure can formulate the amplitude and phase together as a single time-of-flight hologram and embed the ToF hologram in the Fourier transform of a single measured image. The embodiments disclosed herein can entail minimal changes to the imaging hardware. To show the efficacy of the proposed system, embodiments of the present disclosure were evaluated on various scenes, illumination conditions, and embedding mechanisms, as demonstrated in Examples 1 and 2. Noise analysis was performed mathematically and validated on real-world scenes to show that the disclosed embodiments result in a reduction in bandwidth without any loss in reconstruction accuracy. As high spatial resolution CW-ToF cameras become more ubiquitous, increasing their temporal resolution by four times makes them more robust to various applications.

The present disclosure includes a device and method that embeds a time-of-flight (ToF) hologram in Fourier space with four times lower bandwidth than past methods. Embodiments of the present disclosure capture an image with a spatially varying imaging parameter, take a fast Fourier transform of the measurement, filter the twin, and frequency shift to the center to reconstruct the image from the inverse fast Fourier transform. Embodiments of the present disclosure can formulate the amplitude and phase together as a single ToF hologram and embed the ToF hologram in the Fourier transform of a single measured image.

For example, the system may include at least one continuous-wave amplitude modulated ToF cameras and at least one processor in electronic communication with the continuous-wave amplitude modulated ToF cameras. In an embodiment, the processor is configured to determine an amplitude and phase together as a single ToF hologram and embed the ToF hologram in a Fourier transform of a single measured image.

Further, for example, the method may include receiving, at a processor, images from at least one continuous-wave amplitude modulated ToF cameras, determining, using the processor, an amplitude and phase together as a single ToF hologram, and embedding the ToF hologram in a Fourier transform of a single measured image using the processor.

Continuous-wave amplitude modulated time-of-flight (CW-ToF) cameras, also known as correlation-based ToF or indirect ToF cameras, can be used as flash Lidars to determine the scene depth. These cameras measure light along spatial and temporal dimensions and use the ToF of light to measure the scene's depth. As the sensors are two-dimensional, present-generation CW-ToF sensors capture multiple measurements (e.g., four) to reconstruct the depth. This temporal multiplexing for capturing depth information leads to lower frame rates and spatially misaligned frames that result in motion artifacts. Embodiments disclosed herein make flash Lidar (e.g., a continuous-wave amplitude-modulated time-of-flight or CW-ToF camera) four times faster using a combination of electronics and computation. The disclosed techniques can be used in autonomous cars, robotics, and AR/VR, improving depth measurement speed and making all downstream tasks (e.g., path planning, obstacle avoidance, pedestrian detection, etc.) faster. The acquisition methodology of the CW-ToF cameras can be changed. Implementing this change on the sensor can enable a more compact device.

The output from embodiments of the present disclosure may allow for changes in speed and bandwidth with autonomous robots, robotics, and AR/VR. For example, embodiments may allow for an increase in speed and a reduction in bandwidth. Increased speed and reduced bandwidth may lead to downstream benefits such as increased depth calculation precision of moving scenes for applications of CW-ToF. Further, embodiments of the present disclosure may change how autonomous cars, robotics, etc. operate because faster frames, such as four times faster frames, allow for faster reaction without fundamentally changing the algorithms implemented.

In embodiments, increased speed and reduced bandwidth may occur because embodiments of the system do not need to take multiple images. Additionally, embodiments of the present disclosure may be more accurate than conventional methods, as conventional methods rely on an inverse tangent operation, whereas embodiments disclosed herein use FFT. For example, conventional approaches typically use a lookup table instead of actually performing the inverse tangent to increase speed performance at the cost of some accuracy depending on the density of the lookup table and the interpolation method used to fill in values that are absent in the table.

AMCW refers to amplitude-modulated continuous wave. While the physical operation principles of holography and CW-ToF are different, by representing the ToF measurements as a complex sinusoid, parallels between holography and CW-ToF imaging systems can be determined. These parallels can demonstrate that using a rolling shutter sensor and varying the reference phase during CW-ToF acquisition results in snapshot capture of both the amplitude and depth of the scene. Besides using AMCW, CW-ToF can use an electronic shutter as a reference and electronic multiplication in its physics.

A snapshot CW-ToF imaging technique that measures the amplitude and depth using a single capture is disclosed herein. By defining a ToF hologram as a complex sinusoid whose amplitude and phase are proportional to the intensity and depth of the scene, parallels can be drawn between holography and CW-ToF imaging techniques. While the holography and CW-ToF techniques operate on different physical principles, these parallels allow us to translate off-axis techniques to CW-ToF imaging. By using rolling shutter CW-ToF sensors and changing the reference phase of the coded exposure, the off-axis holography effect can be imitated and ToF holography can be recovered. CW-ToF tends to use AMCW as illumination with an electronic shutter reference and electronic manipulation. Holography tends to use a coherent beam illumination, a planar beam reference, and optical interference. Off-axis measurements tend to use coherent beam illumination, a tilted beam reference, and optical interference. The embodiments disclosed herein can use AMCW as illumination with a rolling shutter reference and electronic manipulation. The snapshot CW-ToF imaging does not produce additional noise in phase estimation.

Embodiments of the present disclosure include a snapshot CW-ToF imaging technique that measures amplitude and depth using a single capture. For example, embodiments may define the ToF hologram as the complex sinusoid whose amplitude and phase are proportional to the intensity and depth of the scene. In some embodiments, parallels can be drawn between holography and CW-ToF imaging techniques. This formulation of the ToF hologram enables the translation of off-axis techniques to CW-ToF imaging. In particular, by using rolling-shutter CW-ToF sensors and spatially varying the reference phase of the coded exposure, the off-axis holography effect can be emulated and the complex-valued ToF hologram can be recovered. In an embodiment, using a rolling-shutter sensor and varying the reference phase during CW-ToF acquisition results in a snapshot capture of the “ToF hologram” that contains both the amplitude and depth (encoded in phase) of the scene.

To achieve snapshot depth imaging, the image formation model of CW-ToF cameras were leveraged and demonstrate the modification to enable the capture of a ToF hologram with unipolar (all-positive decoding function) and bipolar (positive and negative decoding function) codes in embodiments of the present disclosure. Analytical and computational techniques to recover amplitude and depth from a rolling-shutter image and the need for optical prefiltering to prevent aliasing and noise folding are shown herein.

In an example, a hardware setup of embodiments of the present disclosure was built with a Melexis 75027 device with region-of-interest support and a galvanometer to emulate the rolling-shutter effect. Using an embodiment of this device, it was demonstrated that embodiments of the present disclosure reduce data bandwidth and improves frame rate on various scenes containing diffuse, specular, and refractive objects, as discussed in Examples 1 and 2. Embodiments of the present disclosure are robust to dead and saturated pixels, thereby enabling depth imaging with slightly faulty sensors, and extremely bright settings. Design parameters including prefiltering window size, and spatial phase variation rate were evaluated, and provided an experimentally optimal set of values that are agnostic to scene conditions. Examples 1 and 2 empirically show that embodiments of the Fourier-based reconstruction technique are superior to the standard N-bucket technique for reconstruction.

CW-ToF cameras measure depth at each spatial pixel with a temporally modulated light source. The intensity of the scene is encoded in the amplitude, and depth in the phase, of the measurements. Typically, four or more images, with different phases, are required to recover both amplitude and depth. These four measurements are obtained either with a spatially multiplexed sensor (similar to a Bayer pattern), or with sequential measurements. Spatial multiplexing results in severe aliasing artifacts and is inherently expensive and cumbersome to manufacture. In contrast, sequential measurements invariably result in motion artifacts when capturing dynamic scenes.

CS-ToF is a compressive ToF imaging architecture aimed at overcoming sensor manufacturing limitations. As compressive sensing relies on the assumption of a linear measurement process for high resolution image estimation, CS-ToF uses a phasor representation of the ToF output to create a linear model between the scene and ToF measurements. Laser light is reflected off of an object onto a high resolution digital micro-mirror device (DMD), and then relayed onto a lower resolution ToF sensor. By changing the DMD codes across multiple exposures, CS-ToF performs spatiotemporal multiplexing of the scene's amplitude and phase. However, sacrificing temporal resolution for spatial resolution. CW-ToF has also been combined with other modalities such as spectrum, light transport, and light fields that have expanded the applications of CW-ToF cameras. There are few, if any, approaches that capture CW-ToF data in a snapshot manner, that is crucial for dynamic scenes.

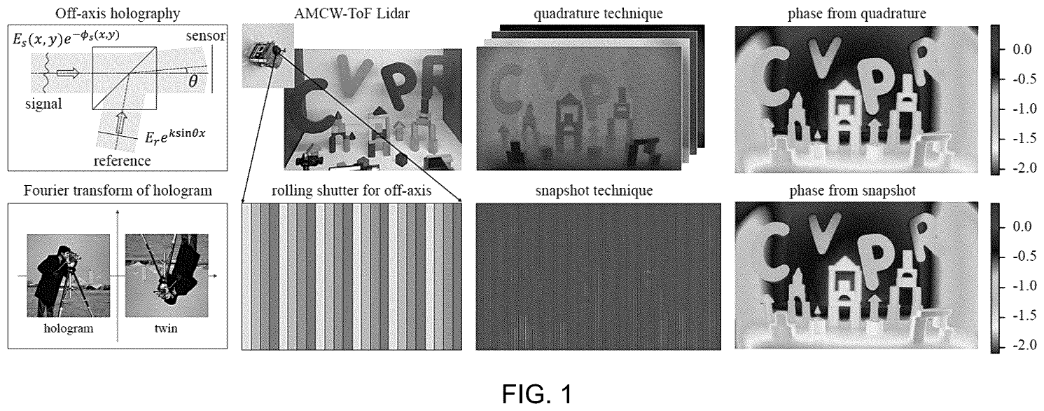

Off-axis holography is an imaging technique for reconstructing the amplitude (Eₛ(x, y)) and phase (ϕₛ(x, y)) of a hologram with a single measurement. The experimental setup schematic is shown in the first column of FIG. 1. The measurement by the camera is given by Equation (1).

$$\begin{matrix}I = {\vert {E}_{s} ( x , y ) {e}^{- j {ϕ}_{s} ( x , y )} + {E}_{r} {e}^{- jkxsin ( θ )} \vert}^{2} \\ = {\vert {E}_{s} ( x , y ) \vert}^{2} + {\vert {E}_{r} \vert}^{2} + {E}_{r}^{*} {E}_{s} ( x , y ) {e}^{- j ( kxsin ( θ ) x + {ϕ}_{s} ( x , y ) )} + \\ {E}_{r} {E}_{S}^{*} ( x , y ) {e}^{j ( - kxsin ( θ ) + {ϕ}_{s} ( x , y ) )}\end{matrix} \qquad ( 1 )$$

where I=intensity; (x,y)=image dimensions; E(x,y)=amplitude of the wavefront; e=Euler; ϕ=phase; θ=angle at which the reference beam is tilted with respect to the object beam; k=wave number; and j=an imaginary unit for the complex light waves.

The off-axis holography embeds the hologram (Eₛ(x, y)e^{-ϕs(x,y)}) and its twin (E*ₛ (x, y)e^{ϕs(x,y)}) separately in the Fourier domain allowing the hologram to be recovered computationally. Off-axis techniques can be used in synthetic wavelength interferometry. In an example, the system includes a co-located, dual wavelength illumination source and two, spatially separated reference beams. For example, the two reference beams may be roughly collocated. As such, in an embodiment, one of the beams points may be at a slight angle in the y-axis (vertically to the sensor) and the other points may be at a slight angle in the x-axis (horizontally to the sensor) with respect to the scene. This causes the hologram corresponding to the different wavelengths/angles to be embedded in different parts of the Fourier spectrum. The separated location implied that the phasor information was encoded in different parts of the Fourier spectrum, enabling frequency domain post-processing to estimate the depth information with a single image. Embodiments disclosed herein can be enabled by (i) expressing a ToF image formation model with phasors that allows parallels to be drawn between holography and an AMCW-ToF imaging system and (ii) using a rolling shutter effect to allow an off-axis technique to be emulated.

In an embodiment, the illumination source may be one or more lasers. For example, synthetic wavelength interferometry may use two illumination sources of different wavelengths, such as two different lasers. In embodiments, the wavelengths may be different, but very close together. For instance, the wavelengths of the lasers may be 535 nm and 535.01 nm.

Beyond depth imaging, CW-ToF cameras can enable applications in imaging. For example, a CW-ToF camera can enable difference imaging, which can be useful for implementing convolutional operations within a sensor. ToF sensors also can be used to tease out sub-surface features through epipolar gating. A light transport matrix-based formulation of ToF measurements can enable measuring multipath interferences that enable measuring geometric properties of complex objects like metal and glass. Embodiments disclosed herein enable other applications beyond depth imaging, including sub-surface imaging and multipath interference reduction (e.g., via epipolar gating).

FIG. 1 displays an embodiment of the snapshot Lidar imaging system disclosed herein inspired by off-axis holography techniques (as shown in the first column). Off-axis holography uses oblique illumination to separate the hologram and its twin in Fourier space (as shown in the second column). Embodiments of the present disclosure leverage the rolling-shutter effect of amplitude modulated continuous wave time-of-flight (AMCW-ToF) cameras to emulate the off-axis principle, thereby separating the ToF hologram and its twin in Fourier space (as shown in the third column). The conventional operation of AMCW-ToF Lidars requires four measurements, whereas embodiments disclosed herein are four times faster, improving both the data bandwidth and temporal resolution (as shown in the fourth column). As shown, the reconstructed phase (that encodes depth) from measurements is similar even with four times fewer measurements. The disclosed technique is four times faster, which improves both the bandwidth and temporal resolution. As shown, the capture time decreased by four times for similar depth estimation. Further, the disclosed technique is four times faster in capture speed because conventional AMCW-ToF cameras take four images sequentially to calculate one depth image. Embodiments of the methods disclosed, by contrast, only require one image, and is this able to capture four depth images for every one captured through conventional methods. As a result, the processing speed is faster than a convention camera. Because a conventional camera takes four images, it requires four times larger bandwidth to transmit them, and four times larger storage in comparison to embodiments of the present disclosure.

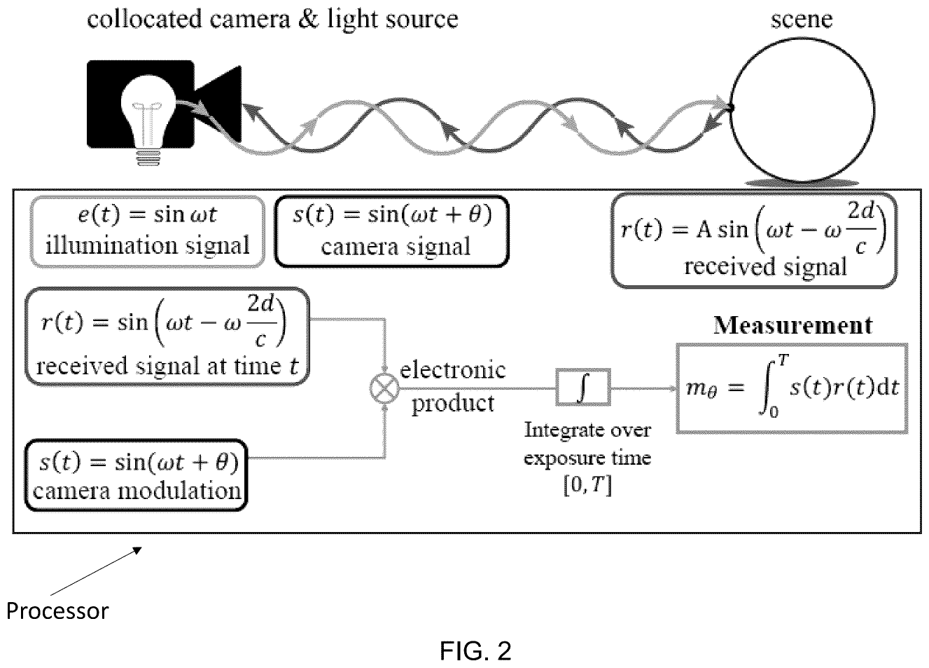

As shown in FIG. 2, the AMCW-ToF camera, also known as indirect ToF cameras has an illumination source whose amplitude (e(t)) changes sinusoidally in the order of tens of MHz. However, other modulation functions can be used. The light received (r(t)) at the sensor is attenuated and delayed based on the light transport of the scene (r(t)=Ae(t−τ)), where τ is the total time-of-travel of the light beam. Assuming a collocated light source and sensor and no multi-bounce paths, τ=2d/c, where d is the distance of the object and c is the speed of light. The sensor temporal exposure (s(t)) is also modulated, typically as a square wave (unipolar or bipolar) with the same frequency as the illumination frequency. Recent sensors mostly use bipolar coding with a two-bucket architecture, and the exposure duration is approximated with a sinusoidal modulation. The measurement by the sensor is given by Equation (2).

$$\begin{matrix}{m}_{θ} = \frac{1}{T} {\int }_{t = 0}^{T} Ar ( t ) s ( t ) dt \\ = \frac{A}{T} {\int }_{t = 0}^{T} sin ( ω t + ϕ ) sin ( ω t + θ ) dt = \frac{A}{2} cos ( θ - ϕ )\end{matrix} \qquad ( 2 )$$

where m=measurement; T=integration time; A=amplitude; ω=angular frequency; ϕ=phase; and t=time (variable for integration).

Most hardware implementations of CW-ToF Lidar measure four images m₀, m_{π/2}, m_{π}, and m_{3π/2} and compute the amplitude and phase as Equation (3).

$$A = 2 \sqrt{{( {m}_{0} - {m}_{π} )}^{2} + {( {m}_{π / 2} - {m}_{3 π / 2} )}^{2}} \qquad ( 3 )$$

$$ϕ = arctan \frac{{m}_{π / 2} - {m}_{3 π / 2}}{{m}_{0} - {m}_{π}}$$

where m=measurement; A=amplitude; and ϕ=phase.

The quadrature technique is also extended to the N-tap technique by taking N measurements corresponding to θ={0, 2π/N, c . . . , 2π(N−1)/N} and computing the amplitude and phase as shown in Equation (4).

$$A = \sqrt{{( {\sum }_{n = 0}^{N - 1} m \frac{2 π n}{N} cos \frac{2 π n}{N} )}^{2} + {( {\sum }_{n = 0}^{N - 1} m \frac{2 π n}{N} cos \frac{2 π n}{N} )}^{2}} \qquad ( 4 )$$

$$ϕ = arctan {\sum }_{n = 0}^{N - 1} m \frac{2 π n}{N} cos \frac{2 π n}{N} / {\sum }_{n = 0}^{N - 1} m \frac{2 π n}{N} cos \frac{2 π n}{N}$$

where m=measurement; n=placeholder variable for summation; A=amplitude; and N=number of measurements.

As shown in FIG. 2, CW-ToF cameras use high frequency illumination sources and exposure codes to indirectly measure the object's depth. The measurement is the product of the delayed illumination signal and programmatically phase-shifted exposure code. The delay encodes object depth and is recoverable by taking multiple measurements with varying phase-shift (θ). Though only one camera is shown in this embodiment, other embodiments include one or more CW-ToF cameras.

Unlike these techniques, embodiments of the present disclosure reconstruct amplitude and phase using a single image.

Generally, in order for the CW-ToF to collect the necessary data for use in embodiments of the present disclosure, the phase shift between the lines to change during the capture is required. This may be implemented in several ways, including using a global shutter sensor and changing the phase shift per line on the sensor; using a rolling shutter sensor and changing the phase shift per line on the sensor or illumination; using a 1D sensor and fast scanning; or using multiple light sources and changing the phase between the light sources. Embodiments disclosed herein may include a CW-ToF that is an AMCW-ToF camera. Further, embodiments disclosed herein can reconstruct the amplitude and phase using a single image.

To measure the amplitude and depth using a single image, the imaging parameter θ linear can be spatially varied along rows or columns during the exposure. In an embodiment, the imaging parameter (θ) may refer to the phase shift (θ) used for modulation. The imaging parameter, or phase shift θ may be a controllable parameter. This spatial variation with hardware modifications by either (1) changing the existing hardware design and having different exposure phase offset per row/column, (2) using a rolling shutter camera and changing the phase offset of illumination or sensor during each row capture, or (3) using fast line sensor (or hardware region-of-interest support camera) and scan the line with a Galvanic mirror. In an example, a fast line sensor was used because Melexis 75027 supports hardware ROI.

To understand how this linearly varying θ embeds both amplitude and phase in the captured image, the amplitude and phase images are represented with the complex sinusoidal notation as I(x, y)=A(x, y)e^{-j2d/c} and the Fourier Transform of this sinusoid as I(ωₓ, ω_{y}). For brevity, ϕ=2d/c is defined as the phase shift of the illumination signal. Varying the θ linearly during the measurement results in Equation (5).

$$\begin{matrix}{m}_{θ = kx} ( x , y ) = \frac{A ( x , y )}{2} cos ( kx - ϕ ( x , y ) ) \\ = \frac{A ( x , y )}{4} ( {e}^{j ( kx - ϕ ( x , y ) )} + {e}^{- j ( kx - ϕ ( x , y ) )} )\end{matrix} \qquad ( 5 )$$

where m=measurement; k=phase variation rate; (x,y)=image dimensions; A=amplitude; ϕ=phase; j=imaginary unit (square root of −1); and θ=angle at which the reference beam is tilted with respect to the object beam.

Taking Fourier transform on both sides results in Equation (6).

$${m}_{kx} ( {w}_{x} , {w}_{y} ) = \frac{1}{4} ( I ( {ω}_{x} - k , {ω}_{y} ) + {I}^{*} ( k - {ω}_{x} , - {ω}_{y} ) ) \qquad ( 6 )$$

where F is the Fourier transform.

This is similar to the off-axis holography Equation (1). Therefore, the complex sinusoidal notation (I(x, y)) is referred to as the ToF hologram (shifted hologram) and its complex conjugate (I*(x, y)) is referred to as the ToF twin (shifted twin).

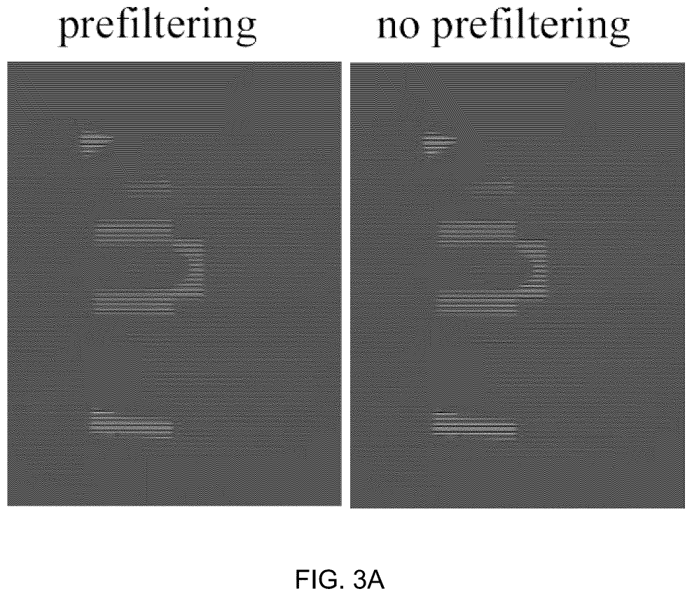

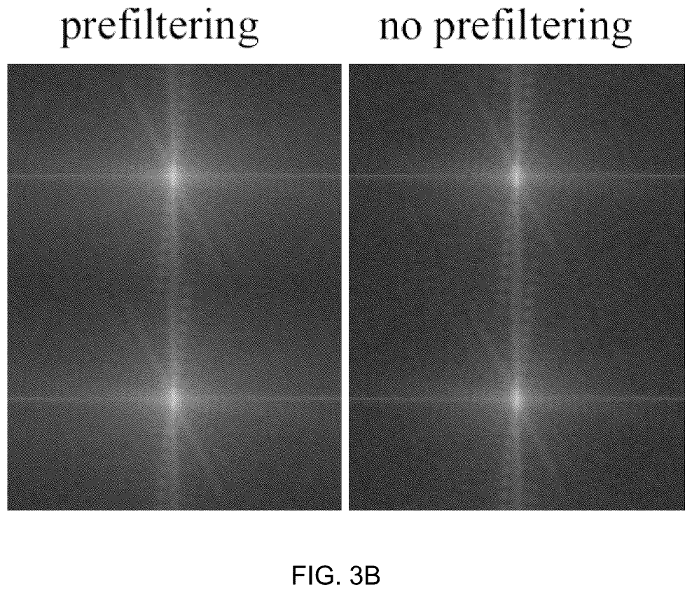

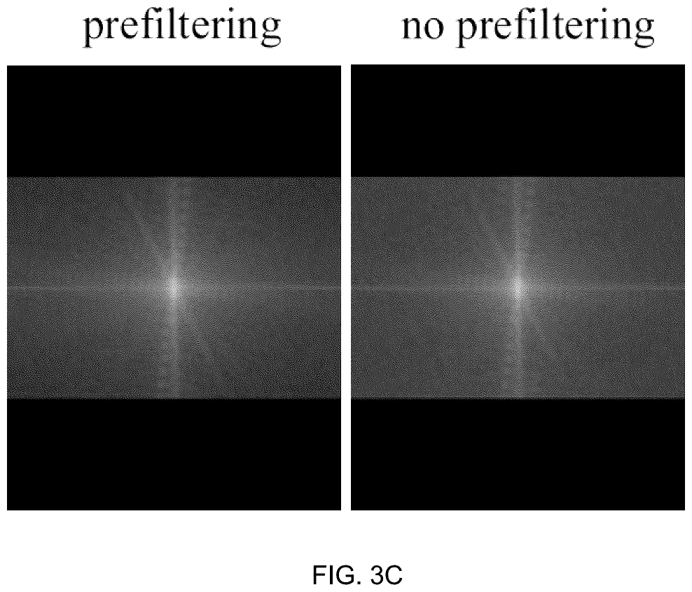

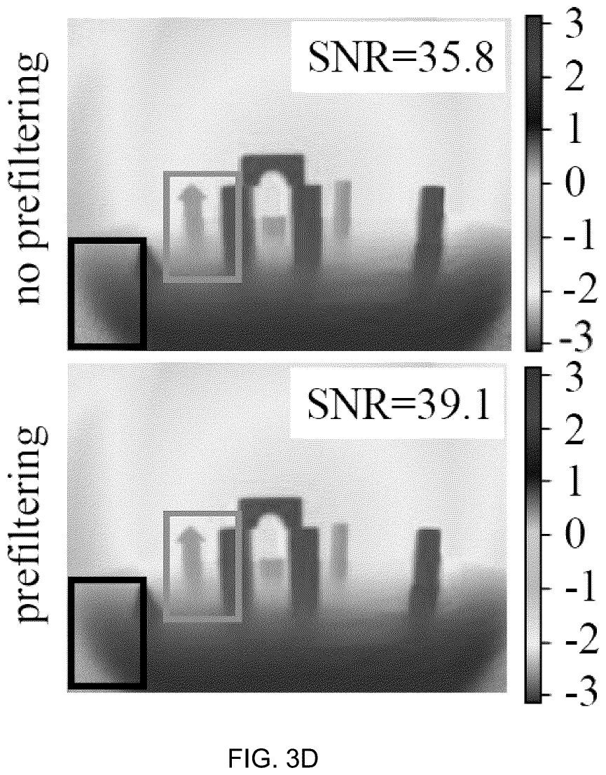

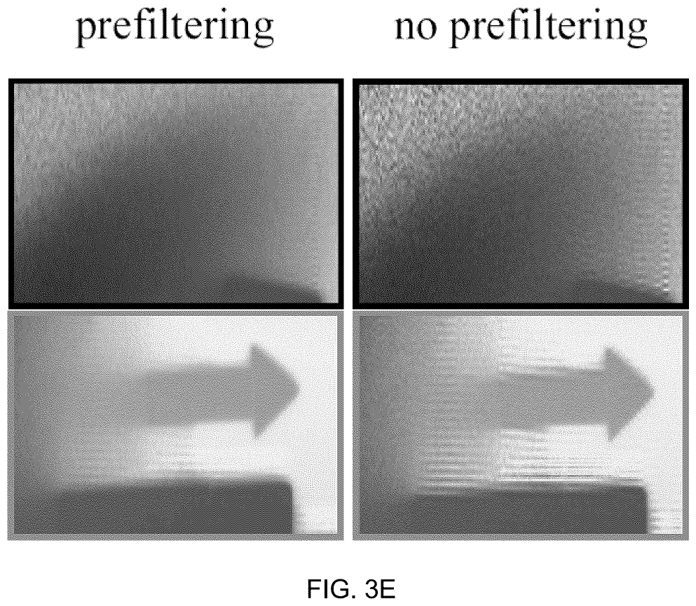

As depicted in FIG. 3A, to recover the ToF hologram from the image captured by varying θ linearly, the Fourier transform of the measured image is taken, the ToF twin is filtered, the ToF hologram has a right shift applied, and an inverse Fourier transform is determined. The amplitude and phase of the inverse Fourier transform result are the amplitude and phase of the scene.

In embodiments disclosed herein, the codes can be bipolar to work with ToF sensors that use a two-bucket architecture to suppress the background illumination. Embodiments disclosed herein also can use unipolar-coded ToF cameras and imperfect two-bucket architecture cameras. In this case, the measurement model becomes that in Equation (7).

$${m}_{θ} = \frac{A}{2} cos ( θ - ϕ ) + a \qquad ( 7 )$$

where m=measurement; θ=phase shift; ϕ=phase; A=amplitude; and a=bias term added to amplitude.

In Equation (7), a is proportional to the ambient background light intensity. In this case, the Fourier transform has a DC component that can be filtered out along with the ToF twin.

As seen in FIG. 3B, the ToF hologram and twin overlap in the Fourier domain. This overlap results in aliasing, where the high-frequency content of the ToF twin may appear as the low-frequency content of the ToF hologram, and noise folding, where the twin's noise folds into the ToF hologram's noise.

To mitigate aliasing and noise folding, the high-resolution ToF hologram is filtered before the linear phase shifting and measurement optically (FIG. 3C). In hardware implementation, this is achieved by defocusing the imaging lens in front of the sensor. This blurring operation reduces the aliasing artifacts and noise folding (FIGS. 3D and 3E).

Specifically, FIGS. 3A-3E display snapshot CW-ToF decoding, and effect of prefiltering. FIG. 3A displays a captured snapshot CW-ToF image. FIG. 3B displays a Fourier transform of the snapshot image. In FIG. 3C, the twin is filtered out and the hologram in the Fourier domain is shifted to recover the ToF hologram. In FIG. 3D, the phase is reconstructed by computing the phase of the inverse Fourier transform of FIG. 3C (top row vs. bottom row). The ToF hologram is prefiltered using a defocused imaging lens, which can decrease the overlap between the hologram and its twin. The prefiltering decreases aliasing and noise folding, resulting in a 3 dB SNR gain (2× smaller phase error). For example, adding a blur by using a defocused lens is like using a mask in the Fourier domain. The hologram and the twin each get multiplied by their own mark in the shape of a Gaussian, which constrains their frequency content to only be inside that mark, resulting in the decreasing overlap between them. FIG. 3E displays zoomed-in offsets (left). Without prefiltering, the high-frequency phase noise of the twin shows up as the low-frequency phase noise (right) aliasing decreases with prefiltering.

Therefore, while the disclosed snapshot Lidar can capture the amplitude and phase with a single image, it may do so by sacrificing spatial resolution for temporal resolution. In an instance, as the spatial resolutions of the imaging sensors keep increasing (compare PMD versus DME660 versus Melexis) due to better fabrication techniques, trading spatial resolution for improving temporal resolution may be more useful.

Apart from the loss of spatial resolution, the recovered phase may have noise due to the shot noise in the measurements. The effect of shot noise can be seen in the standard N-bucket technique. The standard deviation of the phase noise for the snapshot technique is embodied in Equation (8).

$${σ}_{ϕ}^{2} \approx \frac{\partial ϕ}{\partial {m}_{kx}} {m}_{kx} \qquad ( 8 )$$

where mₖₓ=a snapshot measurement; σ=standard deviation; ∂=partial derivative; and
ϕ is explicitly expressed as in the following equation.

$$ϕ ( x , y ) = arctan ( \frac{{m}_{kx} ( x , y ) sin ( kx ) sin c ( kx )}{{m}_{kx} ( x , y ) cos ( kx ) sin c ( kx )} )$$

Here, [symbol] is spatial convolution. An empirical comparison is provided herein to demonstrate that snapshot phase measurement does not result in additional phase noise.

The systems and sub-systems disclosed herein can include a personal computer system, image computer, mainframe computer system, workstation, network appliance, internet appliance, or other device. The sub-system(s) or system(s) may also include any suitable processor known in the art, such as a parallel processor. In addition, the sub-system(s) or system(s) may include a platform with high-speed processing and software, either as a standalone or a networked tool.

The one or more processors of the system(s) may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). In one embodiment, the one or more processors may be embodied as a desktop computer, mainframe computer system, workstation, image computer, parallel processor, networked computer, or any other computer system configured to execute a program configured to operate or operate in conjunction with embodiments of the system, as described throughout the present disclosure. Moreover, different subsystems of the system may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller may include one or more controllers housed in a common housing or within multiple housings. In this way, any controller or combination of controllers may be separately packaged as a module suitable for integration into the system. Further, the controller may analyze data received from the detector and feed the data to additional components within the system or external to the system.

In some embodiments, various steps, functions, and/or operations of systems, the sub-systems, and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor (or computer system) or, alternatively, multiple processors (or multiple computer systems). Moreover, different sub-systems of the systems may include one or more computing or logic systems. Therefore, the above description should not be interpreted as a limitation on the present disclosure but merely an illustration.

A memory medium may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a magnetic tape, a solid-state drive and the like. It is further noted that memory medium may be housed in a common controller housing with the one or more processors. In one embodiment, the memory medium may be located remotely with respect to the physical location of the one or more processors and a controller. For instance, one or more processors may access a remote memory (e.g., server), accessible through a network (e.g., internet, intranet and the like).

The following examples are presented to illustrate the present disclosure. They are not intended to be limiting in any matter.

### Example 1

The following example provides a description of testing embodiments disclosed herein.

An EVK75027-110-940-2 evaluation kit (EVK) by Melexis was used in this example, which uses diffused 940 nm VCSEL diodes for illumination and a Melexis 75027 CW-ToF sensor. While the sensor is a global shutter, the rolling shutter effect was performed using the sensor's hardware programmable ROI to reduce the per-frame capture/readout to a single row. Though this specific sensor was used in this Example, other sensors may be used in other embodiments. For example, the sensor may have timing and synchronization circuitry to allow for high speed electronic shutter modulation and phase shifting of that modulation.

The EVK75027 was mounted to a linear 3D stage and the view was aligned to a set of two-axis galvanic mirrors (GVS012) from Thorlabs. Then the ROI of the camera was reduced to a single line. The view was steered in Galvos with a DAQ system.

The manufacturer standard lens in the EVK75027 has a wide field of view at 109° horizontal and 78° vertical. The lens and the lens mount were replaced with those for a 16 mm Edmund optics lens. Additionally, the illumination board was separated from the rest of the EVK and mounted on top of the galvanic mirrors for approximate collocation of light source and apparent camera location. The MLX75027 contained a firmware lock on the frame rate at 100 fps, which limited capture speed when the ROI is reduced to only a single line. Embodiments of the present disclosure include versions of Melexis cameras without a firmware lock that enable a real-time operation.

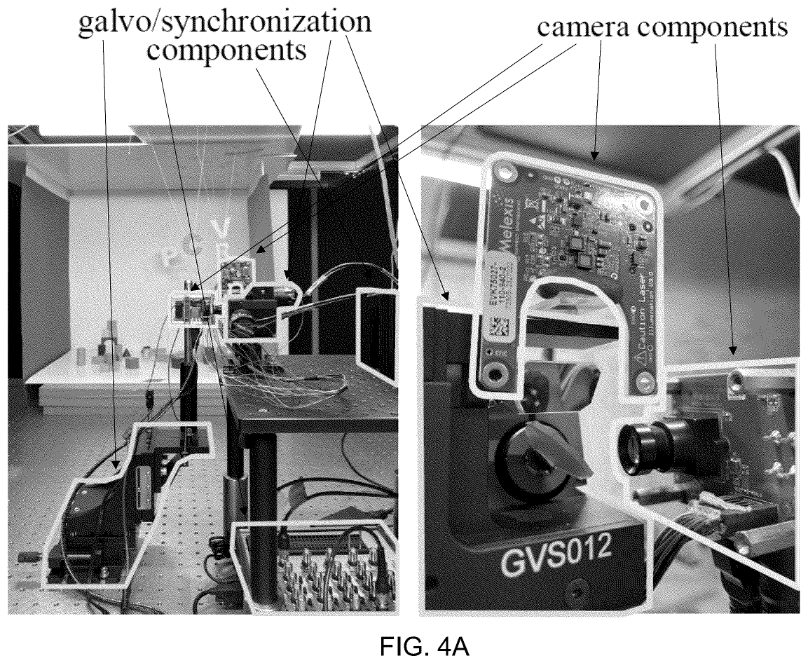

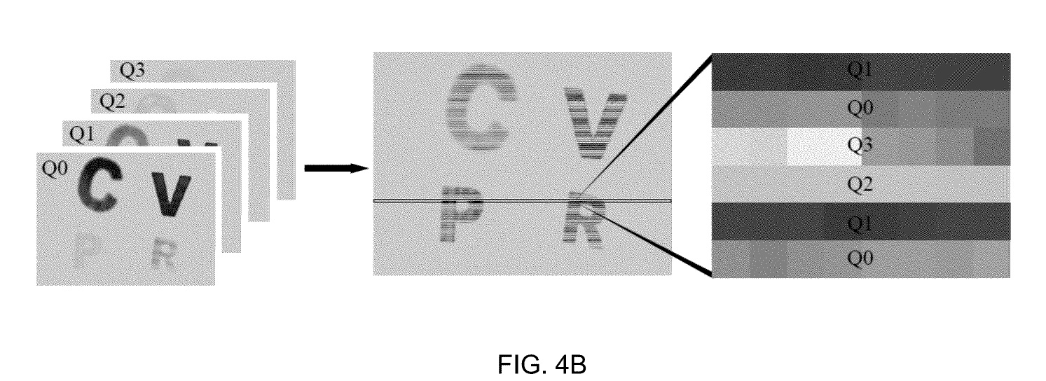

One way to emulate snapshot measurements from the disclosed setup is to capture multiple images with varying phases and appropriately select the rows/columns in the image. FIG. 4A displays the hardware prototype with fast-scanning galvonic mirrors used in this example. Rolling shutter hardware prototype with the camera components and galvanic mirrors/synchronization hardware are outlined. The Melexis ToF camera and hardware ROI support are used to scan only one row at a time. Other rows are scanned by steering the imaging beam using a galvo system. For every scanline, the phase shift (θ) of the camera is changed linearly. Though one camera is shown in this embodiment, other embodiments include a plurality of cameras. For example, one or more cameras in communication with each other. Synchronization between galvo mirrors and the camera can be achieved with the help of NI-DAQ USB6363. The NI-DAQ is a device that allows for sampling of signals. It can sample an analogue signal and convert it to digital for processing or take a digital signal and product an analogue signal. It was used for both cases in this example. For example, the camera outputs an analogue voltage signal to act as a trigger, that trigger is captures in the NI-DAW, and used to trigger a digital signal that can be converted to analogue, which is then sent to the galvo system.

In embodiments of the present disclosure, the snapshot hardware method can capture all the rows within one frame capture duration. FIG. 4B displays compositing quadrature images to create an emulated rolling shutter snapshot. In a row/column from each phase measurement (quadrature in case k=2π/4) is stitched to create a composite image that emulates the rolling shutter effect. While the snapshot hardware setup described in FIG. 4A can capture full-frame with the exposure duration, due to the firmware lock, it only captures 100 rows per second. Therefore, the emulation technique is faster and more convenient.

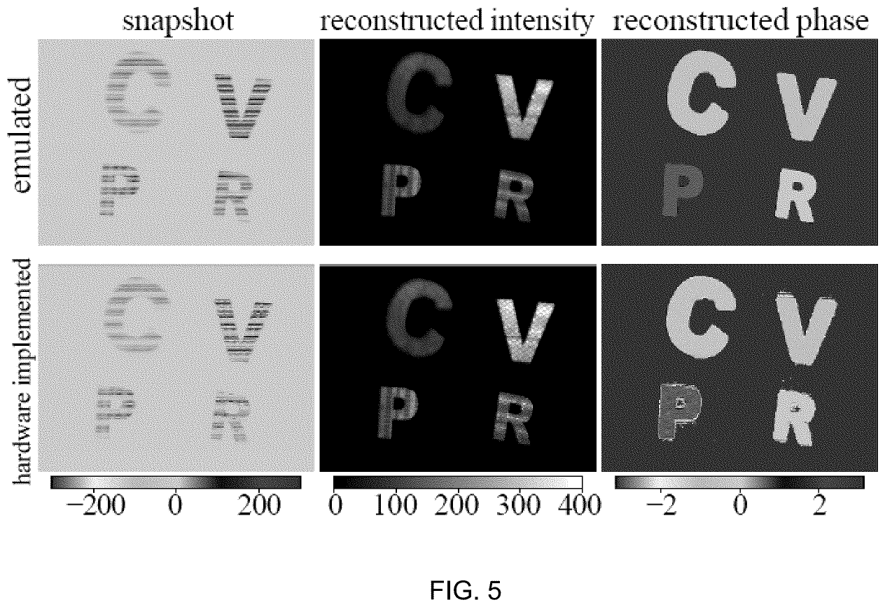

Additionally in FIG. 5, the results from an emulated versus hardware implemented snapshot capture were compared and it was noticed that the techniques result in the same amplitude and phase estimates.

Specifically, FIG. 5 displays the advantages of emulated snapshot capture. As shown, amplitude and depth reconstructed by snapshot data captured with emulations as disclosed herein versus a single line ROI (ideal optical setup) and galvanic mirrors. The emulated measurements and the reconstructed phase are similar to the full prototype tested in this Example. Thus, this example demonstrated all experiments with an emulated setup, as it enables a faithful evaluation of a true snapshot system.

The hardware setup and emulation technique described herein were performed to evaluate the proposed snapshot technique systematically. The experiment demonstrated that (1) prefiltering improves signal-to-noise ratio (SNR) and prefiltering with cylindrical lenses is better than regular lenses; (2) the optimal phase variation rate is (k=(π/2)line⁻¹); (3) the Fourier technique is superior to the N-bucket technique for the snapshot images; (4) the snapshot technique does not add any additional noise and (5) is robust to saturated and dead pixels; and (6) rotating the phase variation (by rotating the camera itself) decreases aliasing.

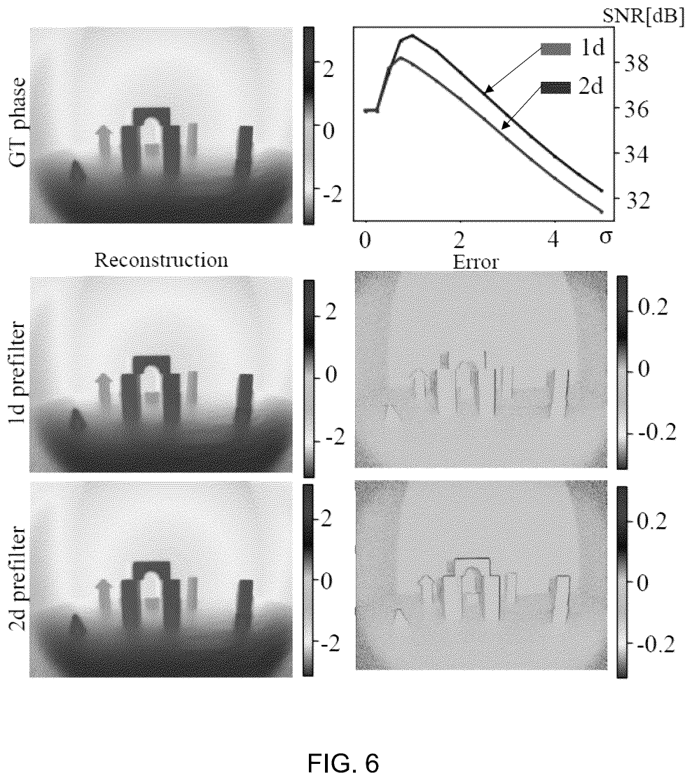

As mentioned herein, prefiltering reduces aliasing and noise folding artifacts. As aliasing and noise folding occur in the direction of the rolling shutter, blurring the ToF hologram only in the rolling shutter direction can be better than isotropic blurring as shown in FIG. 6. Hardware anisotropic blurring can be implemented by using a defocused cylindrical lens. Note that the optimal kernel for prefiltering is a 1D sine function in the spatial domain (corresponding to eliminating all the overlapping frequencies). However, a Gaussian function may also be used for prefiltering. For example, a Gaussian function may be used for the AM frequencies during operation.

Specifically, FIG. 6 displays the robustness to noise due to prefiltering. Prefiltering reduces aliasing and noise folding artifacts to improve the reconstruction quality. Compared to the 2D-blur kernel, the 1D-blur kernel in the direction of rolling shutter direction results in a higher-quality reconstruction. Since the ToF hologram and twin overlap occur only in the rolling shutter direction, a 1D blur kernel preserves the spatial frequencies in the direction orthogonal to rolling shutter.

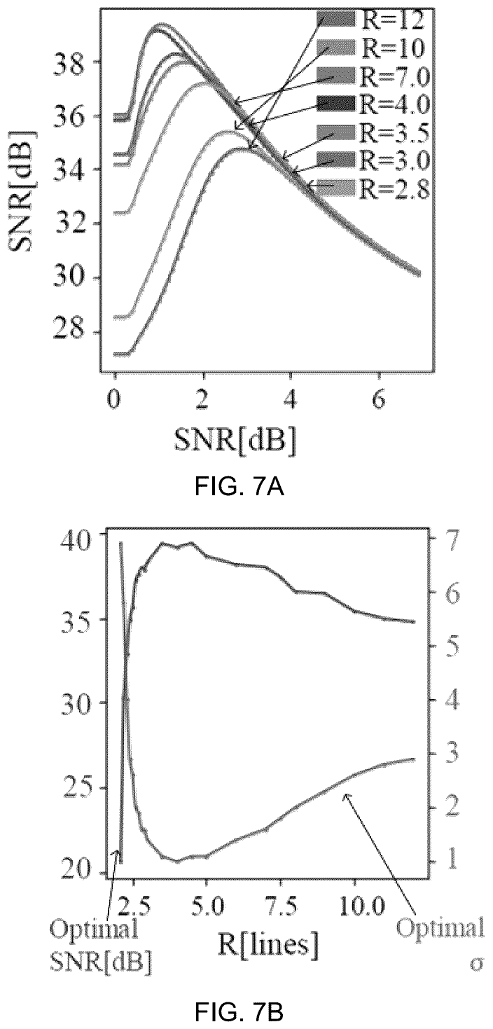

Assuming a 1D-Gaussian prefiltering kernel, the effect of blur kernel size (measured in standard deviation a) on the phase reconstruction accuracy was determined. As shown in FIG. 7A, for all values of phase variation rate (k), the SNR initially improves when a is increased and then decreases showing that an optimal blur kernel size exists. This phenomenon occurs as prefiltering initially reduces the overlap between the ToF hologram and the twin, but later reduces the frequency content in the captured ToF hologram.

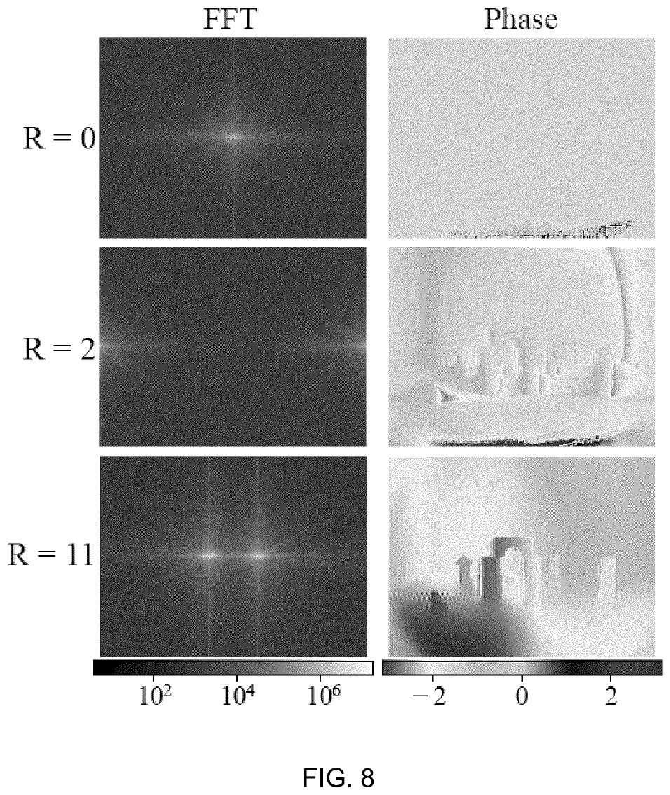

In FIG. 7B, optimal σ value is plotted as a function of R=2π/k, which represents the average number of rows required before θ value resets. From the graph, the best SNR occurs at approximately R=3.5. While the optimal value depends on the noise and frequency content of the scene, it may tend to be approximately R=4.0. The SNR difference between the optimal and R=4.0 may not be significant. At R=4, the overlap between the ToF hologram and the twin is minimal, and σ=1 corresponds to suppressing half of the higher frequency contents. Hence, the optimal SNR is always around R=4 in an example. When R=0, the twin and hologram are inseparable, and the phase cannot be correctly recovered as shown in FIG. 8. The phase variation rate of k=π/2 and σ=1 is used herein. In FIG. 6, the reconstructed phase is visualized at various σ values.

Specifically, FIGS. 7A-7B display the optimal prefilter size and phase variation rate. FIG. 7A displays the effect of the standard deviation of the blur kernel (blur kernel size) on the phase reconstruction accuracy for various phase variation rates (k). The optimal prefilter size depends on the phase variation rate. FIG. 7B displays the best phase reconstruction rate that results in best reconstruction quality that is around R=4, and this is consistently observed for various scenes. R=4 results in the least overlap between the ToF holography and its twin.

Further, FIG. 8 displays visualization of the effect of changing the phase variation rate. In practice, the Discrete Fourier Transform is taken, which is circular. The smaller the overlap between the hologram and twin, the better the phase can be reconstructed. For R=4, the effect of prefilter blur kernel size is visualized. For sub-optimal a, the reconstruction suffers from aliasing and noise folding, and at higher values of σ, the edge information is lost (shown in FIG. 6).

Instead of the Fourier reconstruction method, the standard N-bucket technique can be performed by grouping R-rows with phase variations θ={0, 2π/R, 4π/R, . . . , (R−1)/R}. Note that the N-bucket technique does not decrease the number of effective rows, as R/2 rows can be grouped around the current row to get all the phase variations. However, unlike the Fourier reconstruction method, the N-bucket technique may only work for integer values of R.

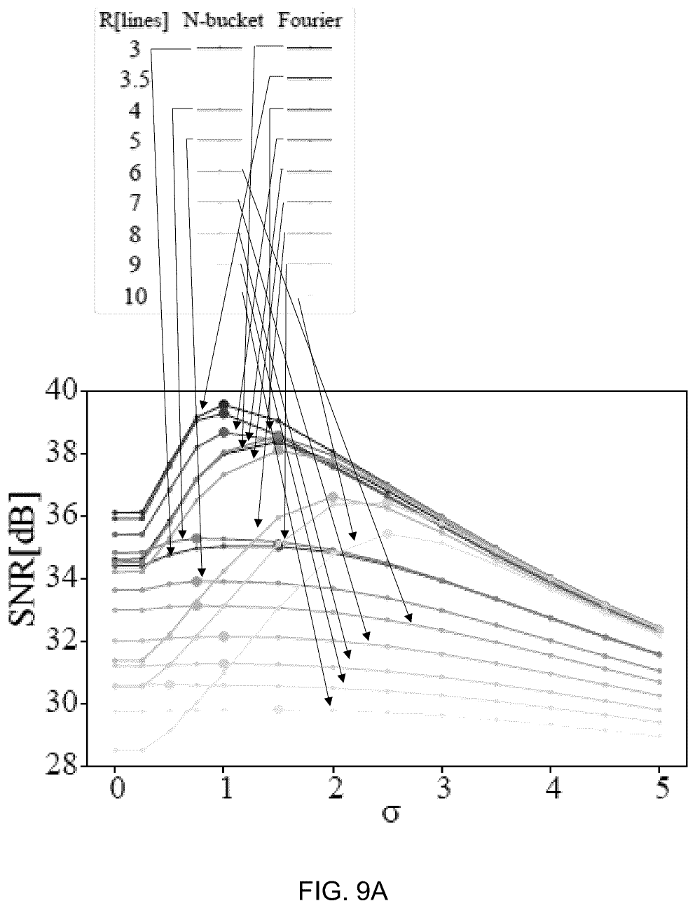

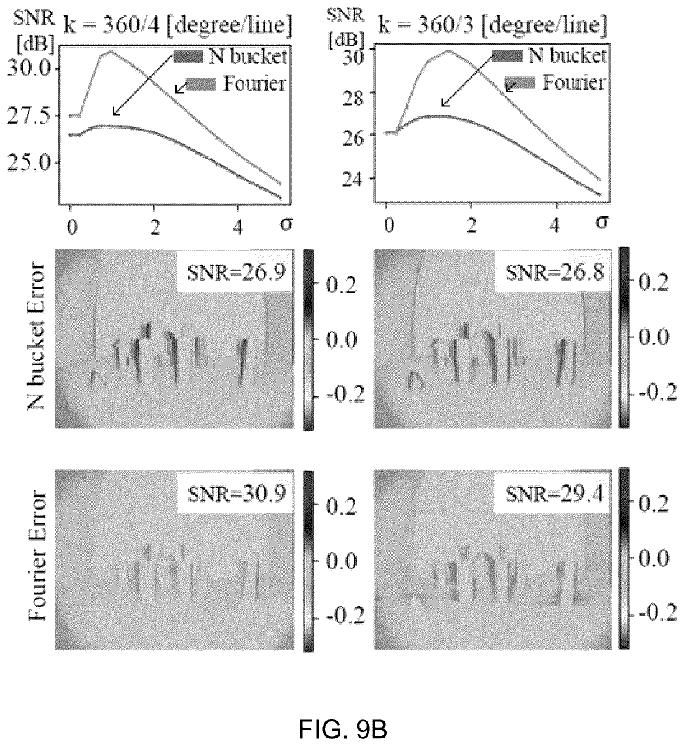

In FIGS. 9A-9B, the N-bucket technique with the Fourier technique is compared. The Fourier technique uniformly works better than the standard N-bucket technique for snapshot phase reconstruction based on the experiment. For the snapshot image, instead of the proposed Fourier technique, the standard N-bucket technique can be used by using neighboring rows as a proxy for the remaining phases. However, the N-bucket technique performs worse compared to the Fourier technique at all the phase variation rates and cannot handle non-integer values of R.

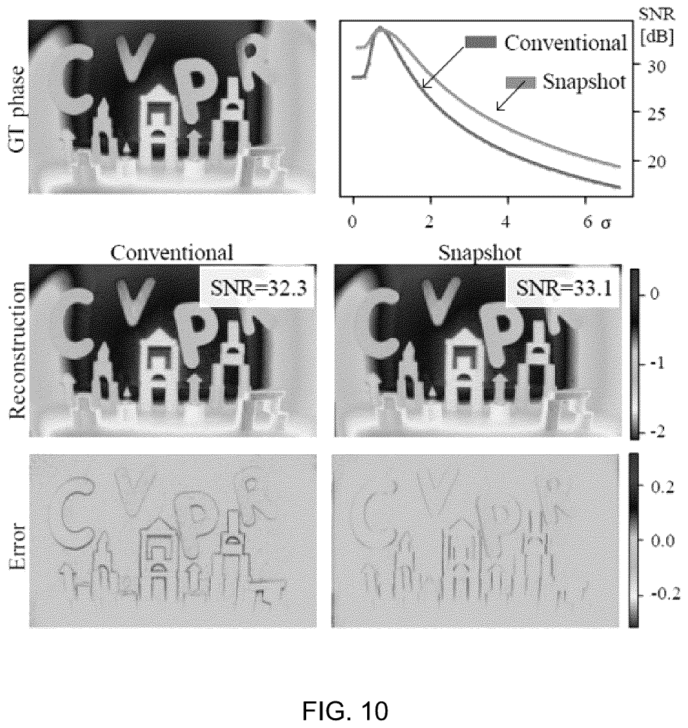

The disclosed snapshot technique is compared with the conventional four-bucket method for the same exposure duration. The snapshot image was captured with an exposure duration of T where T=100 μs while the four quadrature measurements are captured with T/4. In FIG. 10, the phase reconstruction results for both techniques are compared. For a fair comparison, phasors for the conventional and snapshot techniques were prefiltered. The embodiment disclosed herein has an SNR of 29.86 dB for phase reconstruction, slightly higher than 28.56 dB for the conventional method. The disclosed technique performs uniformly better than conventional technique for all a values. While the disclosed technique performs marginally better in this case, the required bandwidth is 4× smaller than the conventional method as our technique requires only one image.

Specifically, FIG. 10 displays comparisons against quadrature reconstruction. For the same total exposure duration and optimal kernel size, embodiments of the method disclosed herein performs similarly or marginally better, compared to the conventional quadrature measurement technique. Importantly, however, embodiments of the technique as disclosed herein requires 4× less bandwidth.

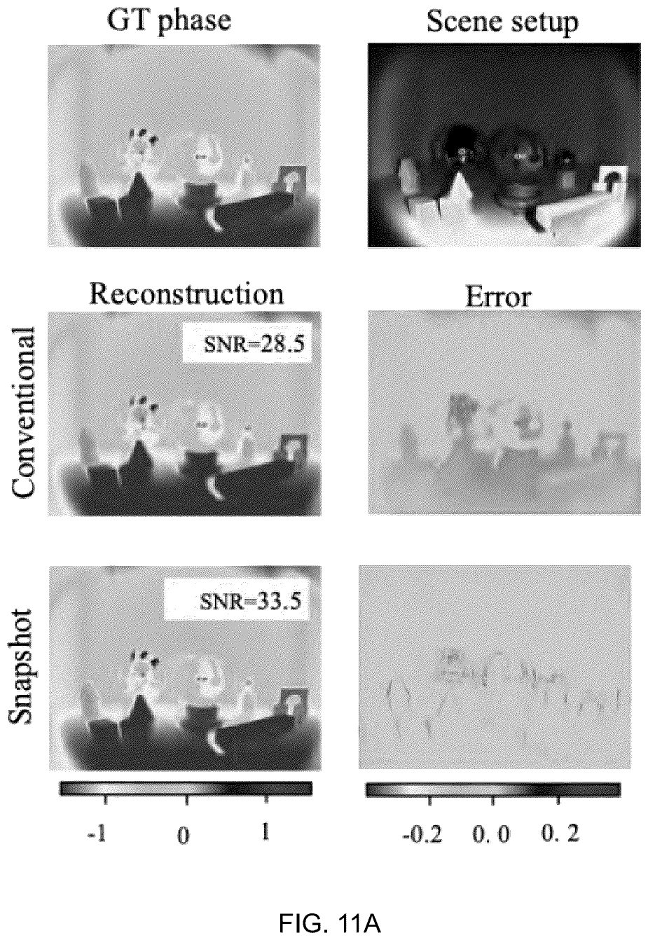

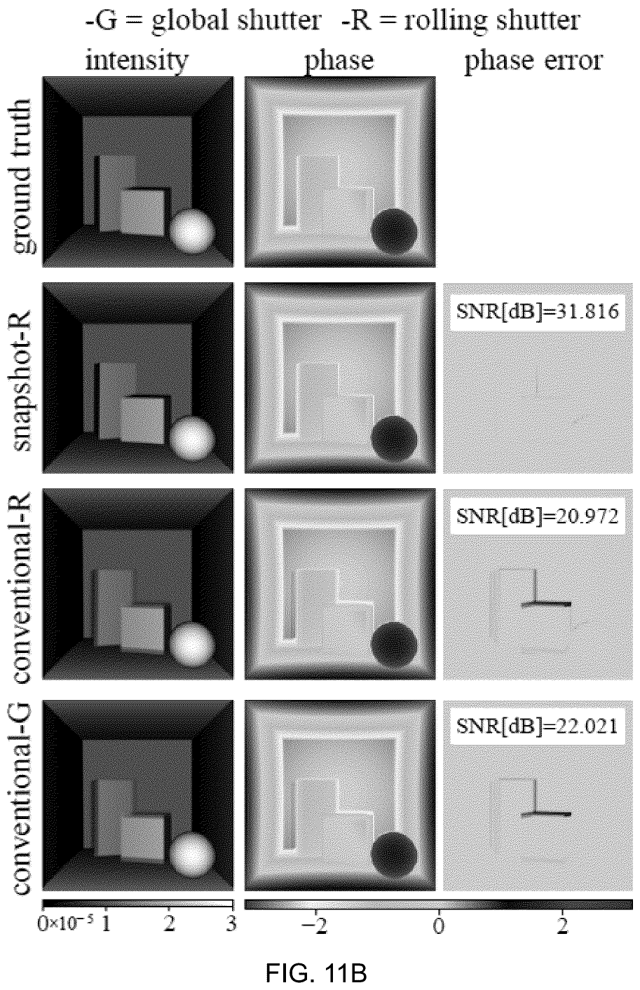

As the disclosed reconstruction method works in the Fourier domain and the Fourier coefficients depend on all the pixels, it appears that local errors may affect overall reconstruction. However, this is not the case, as the reconstructed phase is still in the primal domain. To experimentally demonstrate the same, a scene with specular and refractive objects that result in oversaturated pixels was build. In FIG. 11A, the reconstruction quality of a scene with specular and refractive objects is shown. The results in FIG. 11A demonstrate that the disclosed technique is robust to local saturation. Further, FIG. 11A displays that oversaturated pixels from specular and refractive objects do not affect the reconstruction quality of the neighboring pixels. FIG. 11B displays a comparison between conventional techniques and embodiments disclosed herein for a moving scheme. FIG. 11C displays a comparison of the robustness to local error/oversaturation between conventional techniques and embodiments disclosed herein.

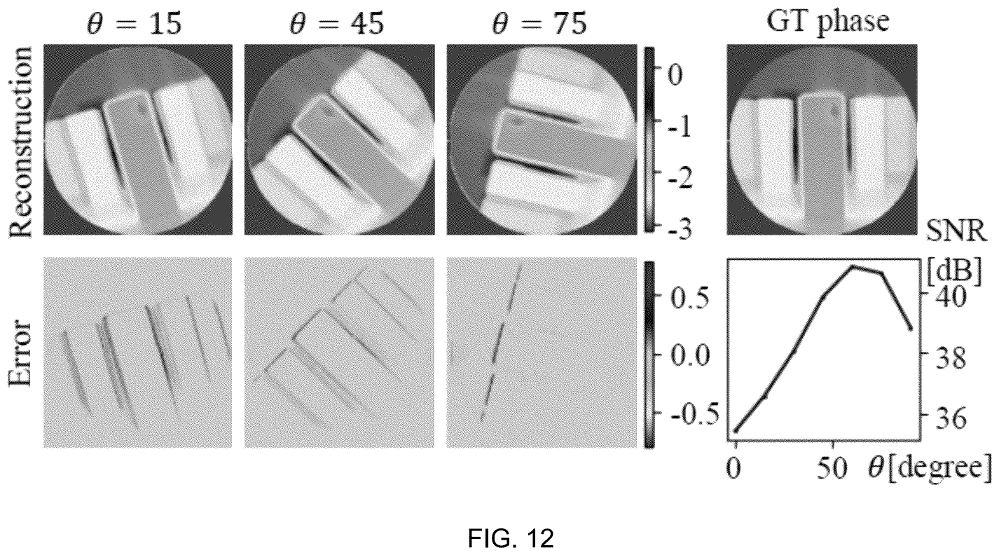

Rotating the Fourier shift direction, implementable by rotating the camera along its optical axis, can also reduce the aliasing artifacts depending on the edges in the scene. An optimal result can be obtained when the majority of the high-frequency edges are not perpendicular to the direction of the phase shift (which is the same as being perpendicular to the phase variation direction). In FIG. 12, the result of reconstructing a scene made up of rectilinear block objects is demonstrated. To make sure the scene stays the same when rotated, a circular mask is applied when comparing the result with the ground truth and compute the SNR. As the graph shows, rotating the input at 75° yields the best result, since only a few rectilinear edges align with the vertical axis, the same orientation for the phase shift.

Specifically, FIG. 12 displays improving reconstruction by rotating the camera. Rotating the rolling shutter or phase variation direction improves the reconstruction quality. When the phase variation direction is perpendicular to the dominant edge direction, the highest SNR can be attained. The phase variation direction can be changed by rotating the camera.

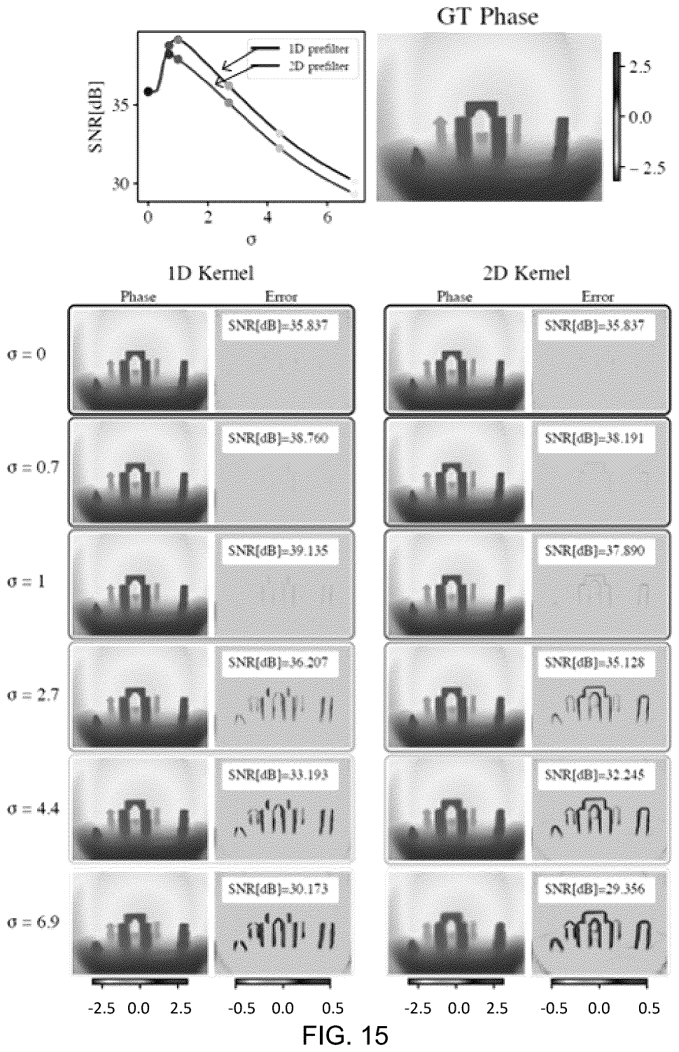

FIG. 15 shows SNR[db] as a function of varying prefilter kernel size σ for both a 1D and 2D Gaussian filter kernel on a snapshot phase reconstruction with k=90°. The 1D kernel consistently performs better than the 2D kernel as it preserves more edges. For the 1D kernel, the optimal σ_{1D} is 1 with an SNR[db] of 39.135. The 2D kernel's optimal σ_{2D} is 0.7, with an SNR[db] of 38.191. FIG. 15 has additional visualizations of FIG. 6.

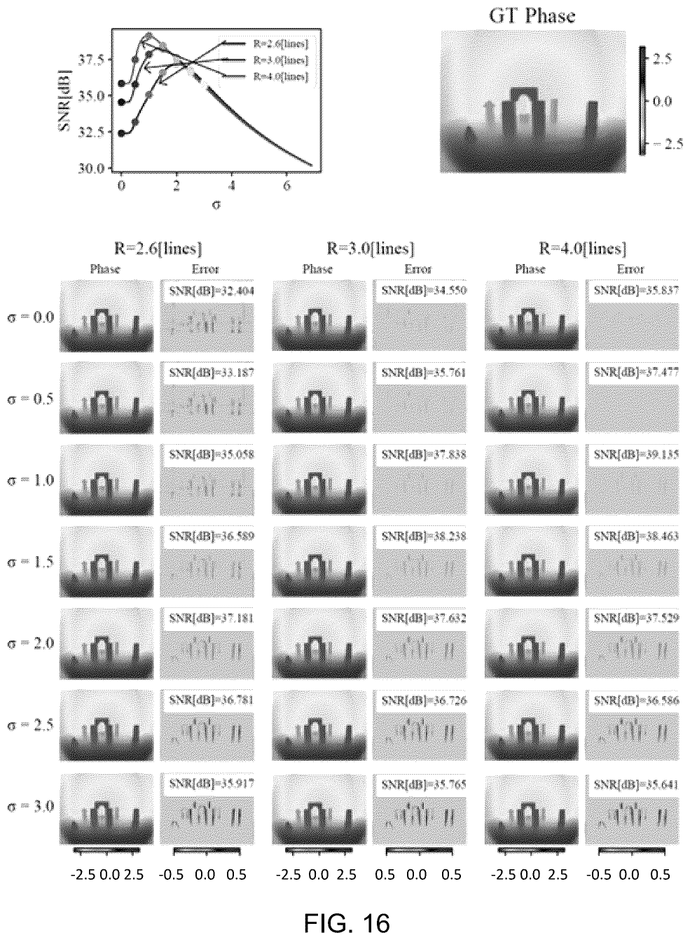

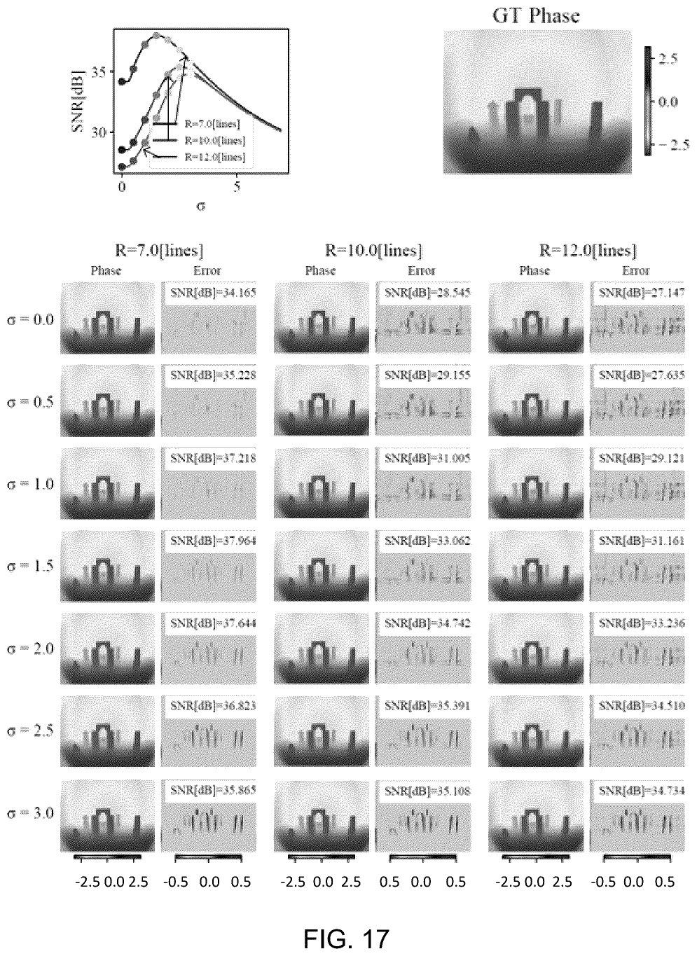

FIG. 16 shows that phase reconstruction quality for a given scene depends on R and a. The overall best quality occurs at around R=4.0 as the overlap between the hologram and twin is minimal at this value. The disclosed technique handles integer as well as fractional R. FIG. 16 has additional visualizations of FIG. 6. FIG. 17 shows more visualizations for FIG. 16.

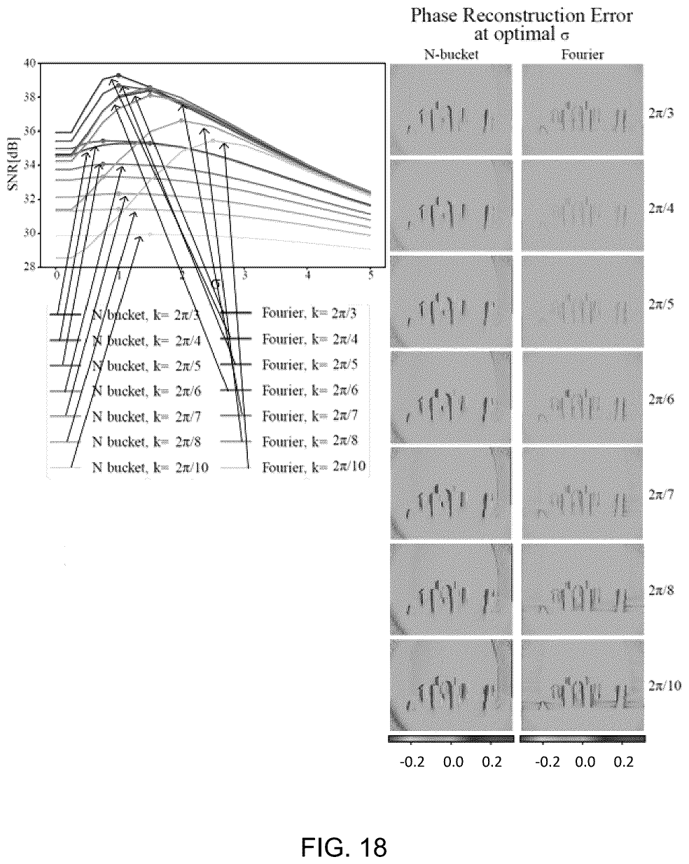

FIG. 18 shows a comparison between the N-bucket and Fourier reconstruction techniques. The graph on the left shows SNR for various values of σ and k for both N-bucket and Fourier reconstruction techniques. The disclosed Fourier reconstruction technique consistently outperforms the N-bucket technique for any k value. The phase reconstruction error is visualized on the right and is then highlighted as points on the left graph. k=2π/9 (40°) is excluded in this visualization because of its proximity to k=2π/8 (45°). FIG. 18 has additional visualizations of FIG. 9B.

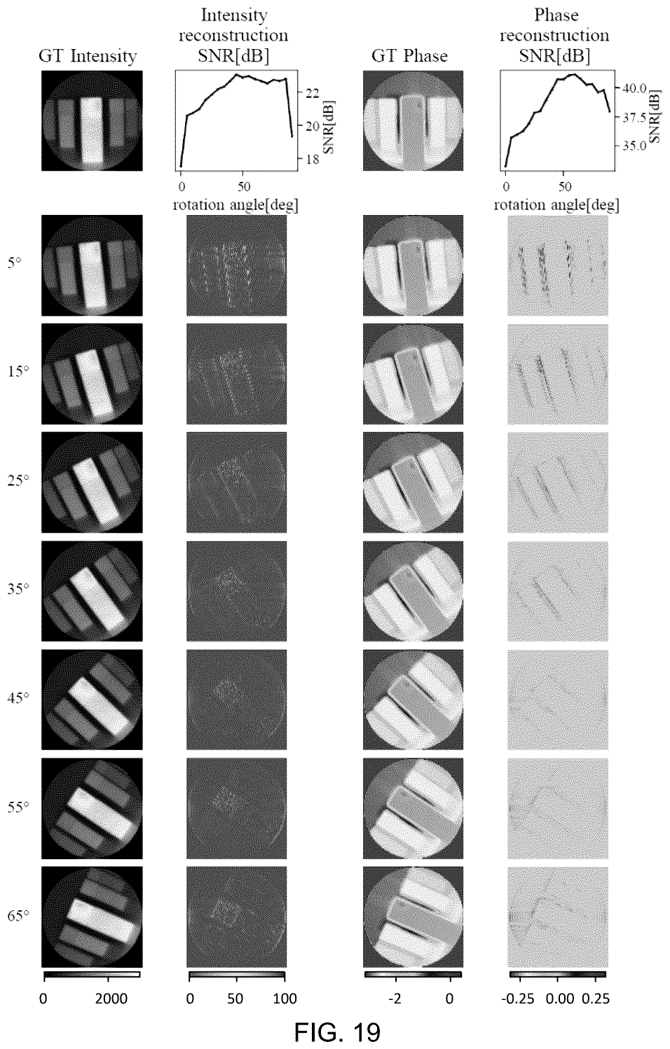

FIG. 19 shows the effects of changing rolling shutter direction (obtained by rotating the camera) on intensity and phase reconstructions with no prefilter and k=90°/line. When the edges are not aligned with the rolling shutter direction, the reconstruction suffers from less aliasing and noise folding artifacts. FIG. 19 has additional visualizations of FIG. 12.

Inspired by off-axis holography, embodiments of the present disclosure include a snapshot Lidar using CW-ToF cameras, which captures amplitude and depth using a single image. This example showed how defining a ToF hologram and using rolling-shutter cameras allows for the translation of off-axis principles to CW-ToF cameras. Extensive experiments with the lab embodiment discussed in this Example demonstrated that the disclosed snapshot imaging approach performs as well as conventional quadrature measurement-based approaches, while requiring 4× fewer measurements.

Translating the snapshot techniques disclosed herein for non-sinusoidal codes, Doppler ToF imaging, frequency-based light transport probing, and time-gating can improve all the applications. Embodiments of the present approach relies on spatial modulation to compute the ToF hologram, which required pre-filtering to avoid aliasing.

Embodiments disclosed herein have translated snapshot off-axis imaging techniques to CWToF imaging. However, a wide variety of imaging ideas including high dynamic range imaging, light-field imaging, polarization imaging, and spectral imaging today are implemented with assorted pixels, which are expensive, prone to aliasing, or require custom demosaicking algorithms.

This experiment demonstrates that a snapshot Lidar using CW-ToF cameras can be used, which captures the amplitude and depth using a single image. Defining a ToF hologram and using rolling shutter cameras can allow translation of off-axis principles to CW-ToF cameras. Prefiltering can enhance snapshot reconstruction techniques. A hardware prototype demonstrated that the proposed technique reduced bandwidth without compromising SNR. The optimal phase variation rate, prefiltering kernel size, shape, and orientation were determined.

### Example 2

The following example provides a further description of the formulas described above. The variables described in this Example are the same as the variables described above, unless defined otherwise.

The variance of the phase noise for the snapshot technique can be described by the following equation.

$${σ}_{ϕ}^{2} \approx \frac{\partial ϕ}{\partial {m}_{kx}} {m}_{kx}$$

where mₖₓ=a snapshot measurement; σ=standard deviation; ∂=partial derivative; and
ϕ is explicitly expressed as follows:

$$ϕ ( x , y ) = arctan ( \frac{{m}_{kx} ( x , y ) sin ( kx ) sin c ( kx )}{{m}_{kx} ( x , y ) cos ( kx ) sin c ( kx )} )$$

The variance of the measured image can be calibrated using standard noise calibration techniques.

Let Mₖₓ(ωₓ, ω_{y})=F(mₖₓ(x, y)) be the Fourier transform of the snapshot measurement mₖₓ. Fourier transform after filtering the twin and shifting the twin-filtered image is given by the following equation where B is the bandpass filter.

$$\hat{I} ( {ω}_{x} , {ω}_{y} ) = {kx}_{} ( {ω}_{x} + k , {ω}_{y} ) \cdot B ( \vert {ω}_{x} \vert \leq k , {ω}_{y} )$$

The estimated phase of the scene ϕ(x, y) is the phase of the inverse Fourier transform of the previous equation. Therefore, the following applied.

$$arg {- 1}^{} ( \hat{I} ) = arg ( {kx}_{} ( {ω}_{x} + k , {ω}_{y} ) \cdot B ( \vert {ω}_{x} \vert \leq k , {ω}_{y} ) ) ,$$

$$\begin{matrix}\hat{ϕ} = arg ( {m}_{kx} ( x , y ) {e}^{jkx} k sin c ( kx ) ) \\ = arg ( {m}_{kx} ( x , y ) ( cos kx + j sin kx ) k sin c ( kx ) )\end{matrix} ,$$

This is same as the first equation in this example. The amplitude noise can also be estimated as follows.

$${σ}_{A}^{2} \approx \frac{\partial A}{\partial {m}_{kx}} {m}_{kx} ,$$

A is explicitly expressed as follows.

$$A ( x , y ) = {( {m}_{kx} ( x , y ) sin ( kx ) sin c ( kx ) )}^{2} + {( {m}_{kx} ( x , y ) cos ( kx ) sin c ( kx ) )}^{2}$$

However, ToF cameras are often not used for estimating intensity images. Instead, an inexpensive and high-resolution intensity camera is often collocated with the ToF camera.

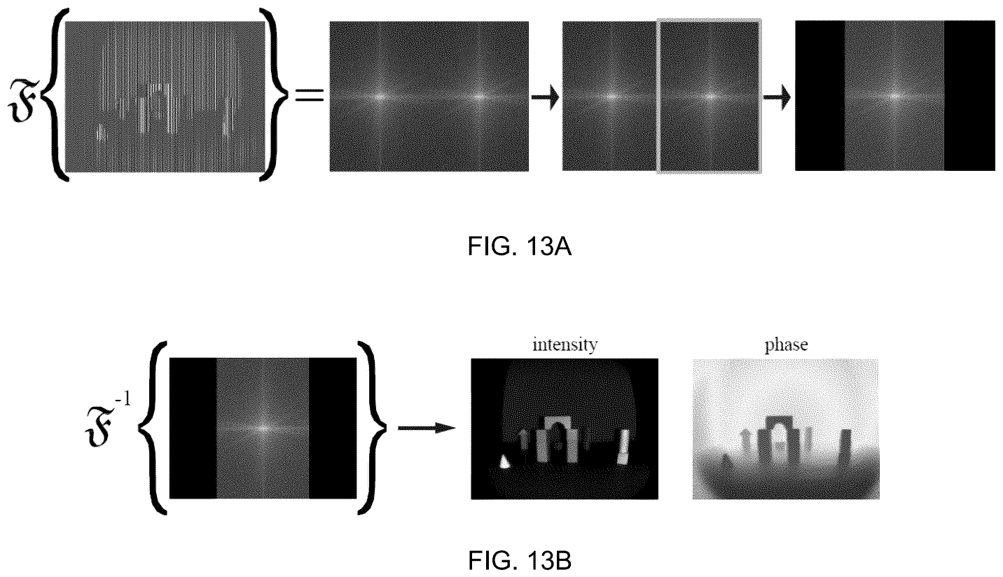

FIG. 4A shows an exemplary snapshot hardware setup. A Melexis ToF camera and hardware ROI support are used to scan only one row at a time. Other rows are scanned by steering the imaging beam using a galvo system. For every scanline, the phase shift (θ) of the camera is changed linearly. Synchronization between galvo mirrors and the camera can be achieved with the help of NI-DAQ USB6363 (as described above). The snapshot hardware method can capture all the rows within one frame capture duration. However, the Melexis has a frame lock on the firmware, which prevents capturing the full frame. Capturing a full frame (480 rows) required around five seconds. In FIG. 13A, the Fourier transform of the captured snapshot image contains both the ToF hologram and its twin. The twin is filtered, and a frequency shift is applied to the ToF hologram. In FIG. 13B, the amplitude and phase of the inverse Fourier transform of the resultant ToF hologram gives the intensity and depth of the scene.

It was demonstrated that the snapshot imaging technique can be emulated by capturing multiple phase measurements and creating a composite image that emulates the rolling shutter effect. The emulation technique is shown in FIGS. 4B and 5.

The epc660 camera and development software by ESPROS can reconstruct the phase using one or two measurements apart from the standard quadrature technique. Specifically, the epc660 CW-ToF sensor has a dual phase mode in which each row alternates as 0 phase shift and π/2 phase shift. The sensor then combines the pairs of rows to create a single depth row, thus calculating the phase in a single capture. In the development software that comes with the epc660, “Dual MGX Mode” enables a feature that calculates the phase with 2 frames captured using the epc660's dual phase mode. The first frame's rows alternate between the π/2 and π phase shifts, while the second frame's rows alternate between the 0 and 3π/2 phase shifts.

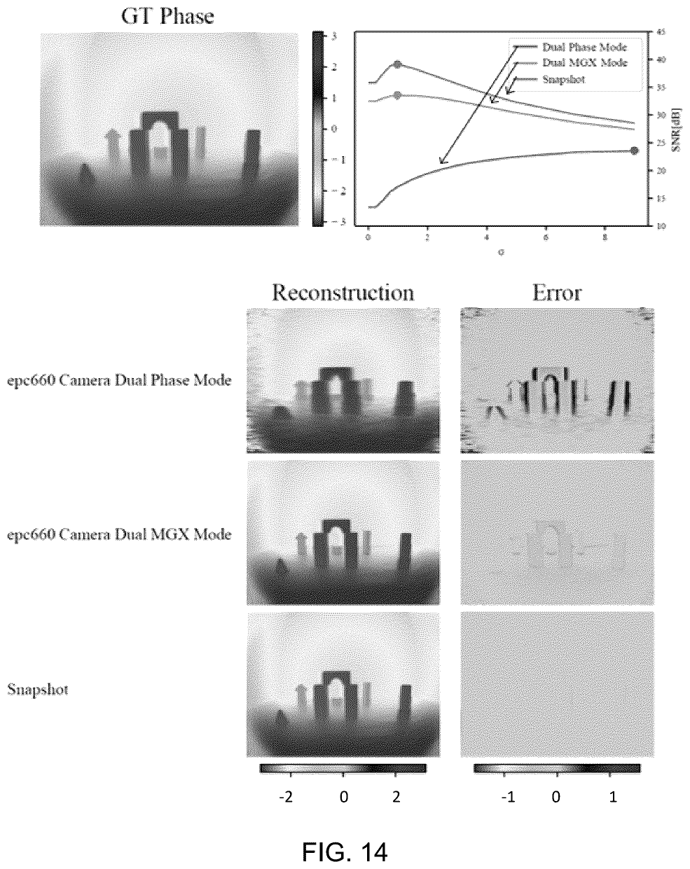

The disclosed method's phase reconstruction to the epc660 dual phase mode and Dual MGX mode methods are compared in FIG. 14. Emulated measurements were created for both methods by stitching rows from quad images with the appropriate phases. To get full vertical resolution from the epc660 and Dual MGX methods, all of the rows in the image were iterated, grouping with the row above to calculate phase.

While the epc660 calculates phase in either single or two captures, the reconstruction error is consistently higher than the disclosed technique, even with prefiltering. This trend is similar to how N-bucket reconstructions performed poorly compared to the Fourier reconstruction method. Note that, for both dual phase and dual MGX modes, the Fourier reconstruction method is not applicable as the phase variation rate is not linear.

Specifically, FIG. 14 displays a comparison between an embodiment of the disclosed technique and an ESPROS reconstruction method at optimal σ values, plotted as points on the SNR graph. Embodiments of the disclosed technique consistently perform better than the ESPROS methods. The epc660 camera's dual phase mode calculates phase in a single frame with each row alternating between 0 and π/2 phase shifted signals. Dual MGX Mode requires 2 frames to calculate phase, making it still susceptible to motion artifacts but improving the reconstruction quality over a single dual phase mode frame. Both the epc660 dual phase mode and Dual MGX Mode techniques result in half vertical phase resolution.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
at least one continuous-wave amplitude modulated time-of-flight camera; and
at least one processor in electronic communication with the at least one continuous-wave amplitude modulated time-of-flight camera, wherein the at least one processor is configured to:
determine an amplitude and phase together as a single time-of-flight hologram; and
embed the time-of-flight hologram in a Fourier transform of a single measured image.

2. The system of claim 1, wherein the amplitude and a depth are measured using a single capture.

3. The system of claim 1, wherein the single time-of-flight hologram is a complex sinusoid, and wherein the amplitude and the phase are proportional to an intensity and a depth of a scene.

4. The system of claim 1, wherein each of the at least one continuous-wave amplitude modulated time-of-flight cameras has an illumination source whose amplitude changes sinusoidally.

5. The system of claim 1, wherein each of the at least one continuous-wave amplitude modulated time-of-flight camera uses a defocused cylindrical lens.

6. The system of claim 1, wherein each of the at least one continuous-wave amplitude modulated time-of-flight camera uses a rolling shutter.

7. The system of claim 5, wherein the defocused cylindrical lens is configured to prefilter images.

8. The system of claim 7, wherein a 1D sinc function or a Gaussian function is used in the prefilter.

9. A method comprising:
receiving, at least one processor, images from at least one continuous-wave amplitude modulated time-of-flight camera;
determining, using the at least one processor, an amplitude and phase together as a single time-of-flight hologram; and
embedding the time-of-flight hologram in a Fourier transform of a single measured image using the at least one processor.

10. The method of claim 9, wherein the amplitude and a depth are measured using a single capture.

11. The method of claim 9, wherein the single time-of-flight hologram is a complex sinusoid, and wherein the amplitude and the phase are proportional to an intensity and a depth of a scene.

12. The method of claim 9, wherein each of the at least one continuous-wave amplitude modulated time-of-flight camera has an illumination source whose amplitude changes sinusoidally.

13. The method of claim 9, wherein each of the at least one continuous-wave amplitude modulated time-of-flight camera uses a defocused cylindrical lens.

14. The method of claim 9, wherein each of the at least one continuous-wave amplitude modulated time-of-flight cameras uses a rolling shutter.

15. The method of claim 13, further comprising prefiltering images using the defocused cylindrical lens.

16. The method of claim 15, wherein a 1D sinc function or a Gaussian function is used in the prefiltering.

17. A non-transitory computer-readable storage medium, comprising one or more programs for executing the following steps on one or more computing devices:
receive images from at least one continuous-wave amplitude modulated time-of-flight camera;
determine an amplitude and phase together as a single time-of-flight hologram; and
embed the time-of-flight hologram in a Fourier transform of a single measured image.

18. The non-transitory computer-readable storage medium of claim 17, wherein the single time-of-flight hologram is a complex sinusoid, and wherein the amplitude and the phase are proportional to an intensity and a depth of a scene.

19. The non-transitory computer-readable storage medium of claim 17, wherein the steps further include prefiltering images using a defocused cylindrical lens.

20. The non-transitory computer-readable storage medium of claim 19, wherein a 1D sine function or a Gaussian function is used in the prefiltering.
